(19) United States
(12) Patent Application Publication
(10) Pub. No.: US 2010/0223545 A1
(43) Pub. Date: Sep. 2, 2010

(54) IP Multimedia Subsystem Service Configuration

(76) Inventors: Mikael Forsberg, Tyreso (SE); Dominique Herve, Roxboro (CA); Hans-Erik Van Elburg, Hagebeemd 5 (NL)

Correspondence Address: ERICSSON INC., 6300 LEGACY DRIVE, M/S EVR 1-C-11, PLANO, TX, 75024, US

(21) Appl. No.: 12/738,019

(22) PCT Filed: Oct. 15, 2007
(86) PCT No.: PCT/EP2007/060973

§ 371 Date: Apr. 14, 2010

(51) Int. Cl. G06F 17/00; G06F 15/16

(52) U.S. Cl. 715/234

(57) ABSTRACT

A method of controlling the presentation of user changeable IP Multimedia Subsystem service conditions at a user terminal, where service conditions are defined within an XML document maintained within the IP Multimedia Subsystem network. The method comprises including within the XML document one or more informational elements identifying those conditions that the user can change and, upon receipt of the XML document or a fragment thereof at the user terminal, interpreting said informational element(s) and presenting to the subscriber only those conditions that can be changed.

### TECHNICAL FIELD

The present invention relates to the configuration of IP Multimedia Subsystem services and in particular to the configuration of such services by users across the Ut interface.

### BACKGROUND

IP Multimedia services provide a dynamic combination of voice, video, messaging, data, etc. within the same session. By growing the number of basic applications and the media which it is possible to combine, the number of services offered to the end subscribers will grow, and the inter-personal communication experience will be enriched. This will lead to a new generation of personalised, rich multimedia communication services, including so-called “combinational IP Multimedia” services.

IP Multimedia Subsystem (IMS) is the technology defined by the Third Generation Partnership Project (3GPP) and ETSI TISPAN group to provide IP Multimedia services over mobile communication networks (3GPP TS 22.228, TS 23.228, TS 24.229, TS 29.228, TS 29.229, TS 29.328 and TS 29.329 Releases 5 to 7, and TS24.173 Release 7). IMS provides key features to enrich the end-subscriber person-to-person communication experience through the use of standardised IMS Service Enablers, which facilitate new rich person-to-person (client-to-client) communication services as well as person-to-content (client-to-server) services over IP-based networks. The IMS makes use of the Session Initiation Protocol (SIP) to set up and control calls or sessions between subscriber terminals (or subscriber terminals and application servers). The Session Description Protocol (SDP), carried by SIP signalling, is used to describe and negotiate the media components of the session. Whilst SIP was created as a subscriber-to-subscriber protocol, IMS allows operators and service providers to control subscriber access to services and to charge subscribers accordingly.

By way of example, FIG. 1 illustrates schematically how the IMS fits into the mobile network architecture in the case of a GPRS/PS access network (IMS can of course operate over other access networks). Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the subscriber that the subscriber is subscribed to; and the Interrogating CSCF (I-CSCF) whose role is to identify the correct S-CSCF and to forward to that S-CSCF a request received from a SIP terminal via a P-CSCF.

Within the IMS service network, Application Servers (ASs) are provided for implementing IMS service functionality. Application Servers provide services to end users in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment (or indeed for the purpose of any SIP method, session or non-session related). The IFCs are received by the S-CSCF from an HSS during the IMS registration procedure as part of a subscriber's Subscriber Profile.

A Ut interface (or more correctly “reference point”) has been specified between the AS and the subscriber terminal (TS23.002). The Ut interface enables a subscriber to manage information relating to his or her services, e.g. creation and assignment of Public Service Identities, management of authorisation policies that are used for example by presence services, conference policy management, etc.

The Ut interface allows in particular a subscriber to manipulate XML data associated with an AS and which defines how certain services are provisioned to that subscriber. XML documents are handled by XML Document Management Servers (XDMS) which are typically co-located with ASs. For example, an XDMS responsible for handling service data relating to Multimedia Telephony services might be co-located with a Multimedia Telephony Application Server (MTAS). In use, an XDMS stores service data into the HSS (as transparent data) which is then retrieved by the AS at service invocation.

ETSI TISPAN has adopted the XML Configuration Access Protocol (XCAP), as specified in IETF RFC4825, for use over the Ut interface and which facilitates the use of http methods, i.e. GET, PUT, and DELETE, to operate on XML data stored in the HSS, via an XDMS. ETSI 183 023 presents a refined XCAP protocol for manipulating data relating specifically to PSTN/ISDN simulation services that will be provisioned within Next Generation Networks (NGN). Such services include for example voice mail, call forwarding, call barring, etc, with each service being defined within the standard by an XML “schema” which represents an XML template for incorporation into subscriber XML documents.

FIG. 2 illustrates schematically the IMS management network in this regard. The XML documents defining customer services and settings are handled by the XDMS 1. A so-called “Sh” interface allows the XDMS to communicate with the Home Subscriber Server (HSS) 2. A provisioning system 3 allows a network operator to initially install pre-configured XML data, based upon the standardised XML schema, on a per-subscriber basis into the HSS, and to subsequently amend the installed XML data via the XDMS. The management network additionally provides a mechanism whereby a subscriber can edit his/her associated XML document. For this purpose, a Ut client 4 is installed within the subscriber equipment or UE. As discussed above, the Ut client uses the XCAP protocol to retrieve (either the whole document or a fragment thereof) and amend the XML document (or fragment). It will be appreciated that the XDMS reacts to a retrieval request from a UE by obtaining the relevant XML data from the HSS and delivering this to the UE over the Ut interface.

An Aggregation Proxy (AP) 5 is arranged to “intercept” XCAP traffic flowing between the Ut client 4 and the XDMS. The role of the AP is firstly to authenticate subscriber originating requests and in particular to determine if a particular user has the right to access the XDMS. Secondly, the AP provides a common point of connection for a Ut client, distributing XCAP requests to appropriate XDMSs.

The Ut client fetches the stored data from the XDMS by sending a XCAP GET request to the XDMS over the Ut interface (assuming authorisation by the AP and redirection by any aggregation point). The XDMS fetches the data from the HSS over the Sh interface and sends it back to the Ut client in a Ut response message. The Ut client displays information and options to the user via a Graphical User Interface (GUI). Typically, the GUI is preconfigured to present certain information depending upon the data received. Whilst the XDMS is able to allow and reject requests by a subscriber to change the XML data, as currently defined the relevant standard does not have any mechanism to limit the possible conditions that can be accessed by the subscriber. That is to say that a subscriber can download his or her XML document relating to a service set, with the GUI rendering that to the user including displaying all service settings, regardless of whether or not the XDMS will actually accept a request to change those settings. Such an approach will inevitably result in unhappy and confused users.

### SUMMARY

In order to address the problem identified above, it is proposed to introduce into the XML document structure (i.e. the standardised schema) an informational element or elements which identifies (identify) the conditions that a subscriber is allowed to change. The elements are interpreted by the GUI at the subscriber terminal, and only those conditions that are changeable are displayed.

According to a first aspect of the present invention there is provided a method of controlling the presentation of user changeable IP Multimedia Subsystem service conditions at a user terminal, where service conditions are defined within an XML document maintained within the IP Multimedia Subsystem network. The method comprises including within the XML document one or more informational elements identifying those conditions that the user can change and, upon receipt of the XML document or a fragment thereof at the user terminal, interpreting said informational element(s) and presenting to the subscriber only those conditions that can be changed.

Embodiments of the present invention provide a mechanism for preventing those conditions which are not changeable from being displayed to a user, or at least for preventing them from being displayed as changeable conditions. Thus, a subscriber will not attempt to change, unchangeable conditions, and subscriber frustration will be avoided.

According to a second aspect of the present invention there is provided apparatus configured to operate within an IP Multimedia Subsystem network as an XDMS server. The apparatus is arranged in use to manage an XML document stored within a Home Subscriber Server of the IP Multimedia Subsystem network and defining service conditions for an associated user, the apparatus being further arranged to accept or deny user originating requests to change the XML document based upon informational elements contained within the document.

According to a third aspect of the present invention there is provided a user terminal for use with an IP Multimedia Subsystem network and comprising a Ut client for interacting with an XDMS server of the IP Multimedia Subsystem network. The terminal comprises a Graphical User Interface arranged to present to a user, changeable IP Multimedia Subsystem service conditions based upon an informational element or elements contained within an XML document or document fragment delivered to the terminal over the Ut interface, the element(s) specifying allowed and/or disallowed conditions.

### BRIEF DESCRIPTION OF THE DRAWINGS

FIG. 1 illustrates schematically the integration of an IP Multimedia Subsystem into a 3G mobile communications system;

FIG. 2 illustrates schematically an IMS management network architecture according to the prior art;

FIG. 3 illustrates schematically the structure of an XML document maintained in an XDMS of the management network architecture of FIG. 2;

FIG. 4 illustrates schematically a UE;

FIG. 5 is a flow diagram illustrating a process of identifying changeable conditions to the Ut client;

FIG. 6 shows a part of an XML document containing additional informational elements; and

FIG. 7 shows a part of an XML document containing additional informational elements according to an optimised format.

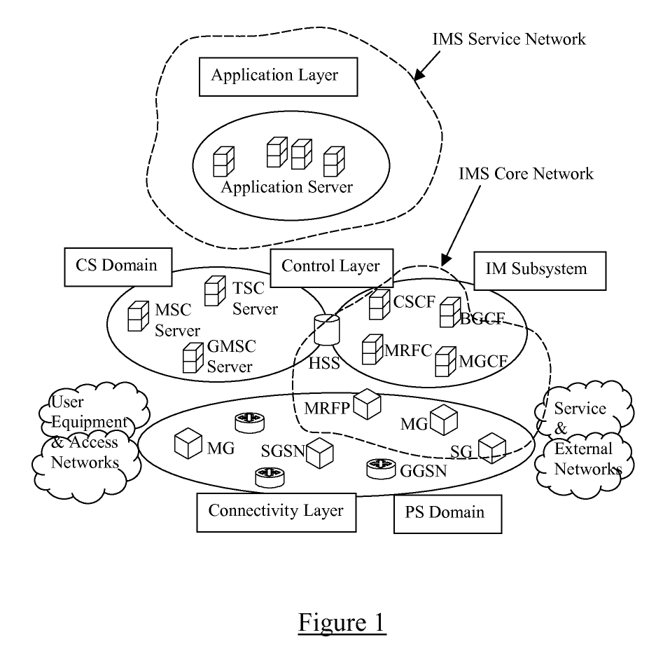

### DETAILED DESCRIPTION

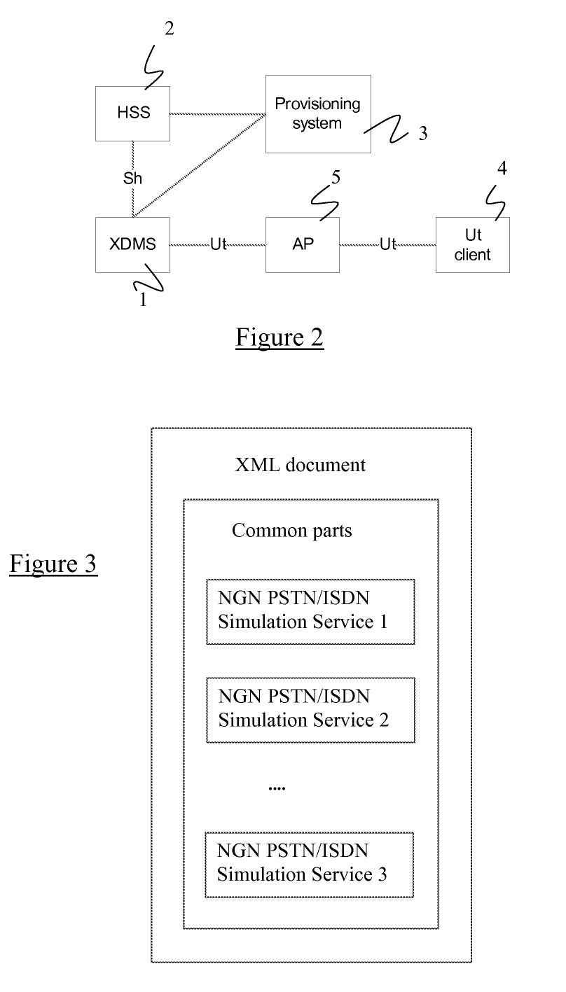

With reference to the prior art IMS management network architecture illustrated in FIG. 2, as has already been described, an XDMS (SIP Application Server) is provided to maintain XML documents defining service provision for associated subscribers. The XML documents are stored within a Home Subscriber Server (HSS) and are retrieved by appropriate SIP Application Servers (ASs) at service invocation in order to allow the ASs to provision services to subscribers according to user subscriptions and network policy.

By way of example, an XML document is created for each network subscriber specifying PSTN/ISDN simulation services provisioned for that subscriber. Each available simulation service is specified within an XML document according to an XML “schema” (the schemas being defined in the relevant standard). In addition, an XML document may contain a “common parts” section (again according to the standardised common parts) which is imported into each of the service specific schemas. The XML document structure is illustrated in FIG. 3. The XCAP protocol is used by a Ut client (at the UE) to access and change the various sections presented within his or her XML document(s).

It is proposed here to extend the standardised service schema with additional information elements that indicate which conditions a subscriber may change. The GUI provided at the subscriber terminals (UEs) is able to interpret the information element(s) contained within a retrieved XML document or document fragment, and display to the subscriber only those conditions that can be changed. If this extension parameter is not included then the Ut client will present all available options for a given service, ensuring that Ut clients supporting the extensions are compatible with XDMSs that do not. The extension shall be added so that legacy Ut clients not supporting this extension do not reject a response originating at an XDMS that does support the extension. It is noted that if a Ut client does not support the extension and seeks to change a service condition that the subscription does not allow, the XDMS will reject that request according to conventional practice. A general architecture for the UE is illustrated in FIG. 4 and comprises a Ut client 10, a GUI 11, and a display 12.

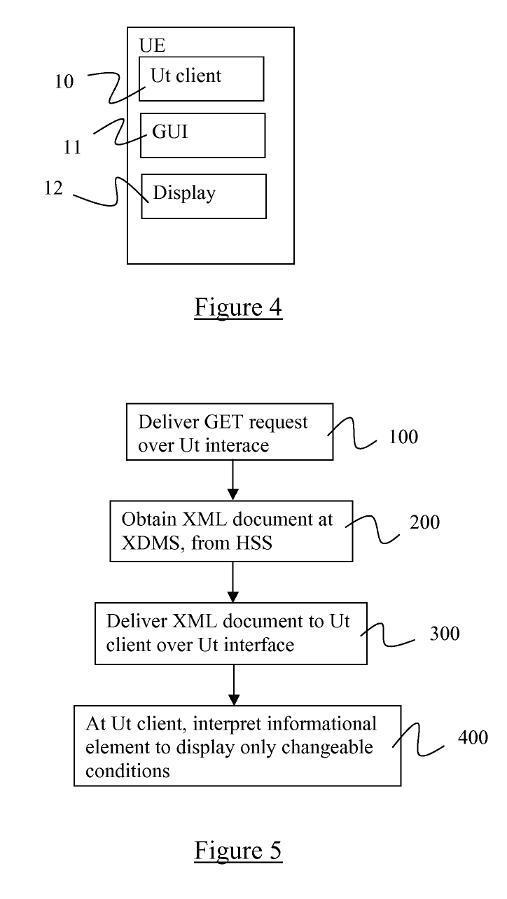

FIG. 5 is a flow diagram illustrating the main steps associated with presenting changeable conditions to the subscriber, namely:
Step 100) Send GET request from Ut client to XDMS over Ut interface;
Step 200) Receive GET request at XDMS and obtain XML document from HSS of Sh interface;
Step 300) Deliver XML document to Ut client over Ut interface; and
Step 400) At Ut client, identify changeable conditions using informational element(s), and display conditions.

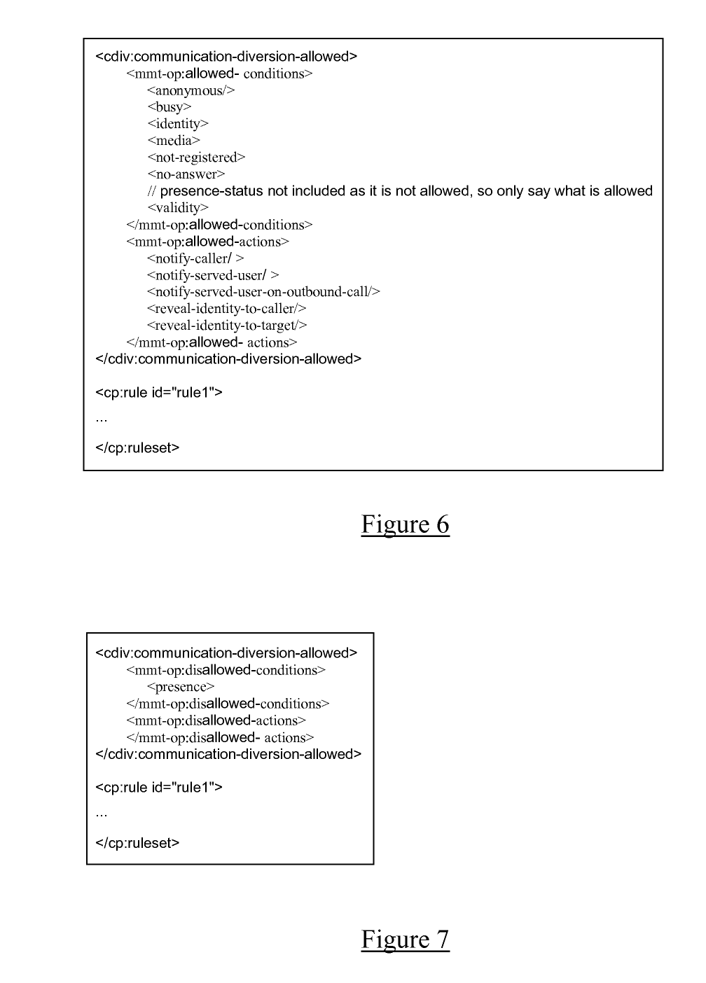

FIG. 6 shows a section of an XML document associated with a particular subscriber and which defines conditions for a call diversion (“cdiv”) service. According to the conventional document structure, the document defines a rule set for the service, including “Rule1”, etc. In addition, the document contains an informational element listing those conditions and actions for the service which the subscriber is allowed to change. The GUI at the Ut client is able to understand this new element, and will display a user interface as appropriate.

FIG. 7 illustrates an optimised XML structure according to which the informational element lists only disallowed conditions and actions. In this example, the only condition which the user is prevented from changing is the “presence” condition. The GUI at the Ut client will therefore present all other actions and conditions to the subscriber as changeable.

It will be appreciated by the person of skill in the art that various modifications may be made to the above described embodiment without departing from the scope of the present invention.

1. A method of controlling a presentation of user changeable IP Multimedia Subsystem service conditions at a user terminal, where service conditions are defined within an XML document maintained within the IP Multimedia Subsystem network, the method comprising:
including within the XML document one or more informational elements identifying conditions that the user can change; and
upon receipt of the XML document or a fragment thereof at the user terminal, interpreting said one or more informational elements and presenting to the subscriber only the conditions that can be changed.

2. The method according to claim 1, wherein said one or more informational elements specify conditions for which change is allowed and disallowed.

3. The method according to claim 1, wherein said XML document or fragment thereof is delivered to the user terminal by an XDMS server over a Ut interface of the IP Multimedia Subsystem network.

4. The method according to claim 1, wherein said XML document is stored as transparent data within a Home Subscriber Server of the IP Multimedia Subsystem network.

5. An apparatus configured to operate within an IP Multimedia Subsystem network as an XDMS server, the apparatus being arranged for managing an XML document stored within a Home Subscriber Server of the IP Multimedia Subsystem network and for defining service conditions for an associated user, the apparatus being further arranged to accept or deny user originating requests to change the XML document based upon informational elements contained within the document.

6. The apparatus according to claim 5, comprising a Ut interface for receiving said user originating requests.

7. The apparatus according to claim 5 and comprising an Sh interface for storing changed XML data as transparent data within the Home Subscriber Server.

8. A user terminal for use with an IP Multimedia Subsystem network and comprising a Ut client for interacting with an XDMS server of the IP Multimedia Subsystem network, the terminal comprising
a Graphical User Interface arranged to present to a user, changeable IP Multimedia Subsystem service conditions based upon an informational element, or elements, contained within an XML document or document fragment delivered to the terminal over the Ut interface, the informational elements specifying allowed and disallowed conditions.
